(19) United States
(12) Patent Application Publication
(10) Pub. No.: US 2007/0286107 A1
(43) Pub. Date: Dec. 13, 2007

(54) System and method for wireless communication of uncompressed video having multiple destination aggregation (MDA)

(76) Inventors: Harkirat Singh, Santa Clara, CA (US); Huai-Rong Shao, San Jose, CA (US); Chiu Ngo, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/724,419

(22) Filed: Mar. 14, 2007

Related U.S. Application Data
(60) Provisional application No. 60/813,152, filed on Jun. 12, 2006.

(51) Int. Cl. H04H 1/00

(52) U.S. Cl. 370/312

(57) ABSTRACT

A system and method for efficiently communicating messages over a low-rate channel between multiple devices in a system for wireless communication of uncompressed video is disclosed. The method includes using multiple destination aggregation to improve the efficiency of the low-rate channel, thereby allowing more time to utilize a time division duplexed high-rate channel for communicating the uncompressed video. The multiple destination aggregation messages can be encoded by any device in the system and received over the low-rate channel by any other device in the system. Receiving devices can determine if any of the multiple messages received over the low rate channel are targeted to the receiving device and subsequently process these messages.

### CROSS-REFERENCE TO RELATED APPLICATIONS

This application claims priority from U.S. Provisional Patent Application No. 60/813,152, entitled “METHOD AND APPARATUS OF MULTI DESTINATION AGGREGATION (MDA) IN WIHD”, filed Jun. 12, 2006, which is incorporated by reference in its entirety.

### BACKGROUND OF THE INVENTION

1. Field of the Invention

The present invention relates to wireless transmission of video information, and in particular, to transmission of uncompressed high definition video information over wireless channels.

2. Description of the Related Technology

With the proliferation of high quality video, an increasing number of electronic devices, such as consumer electronic devices, utilize high definition (HD) video which can require about 1 Gbps (bits per second) or more in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices that do not have the bandwidth to carry the uncompressed HD signals are connected to the network.

### SUMMARY OF CERTAIN INVENTIVE ASPECTS

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments” one will understand how the sample features of this invention provide advantages that may include faster channel acquisitions, improved error recovery and improved efficiency.

An aspect provides a method of communicating messages between a plurality of devices in a system for wireless communication of uncompressed video. The method includes wirelessly transmitting and/or wirelessly receiving uncompressed video over a high rate channel, and receiving a data packet over a low rate channel at a receiving device, the receiving device being identified by a device address, the data packet comprising a header comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses, and a data field. The method further includes determining if the destination address of one or more MDA messages matches the device address of the receiving device, and processing MDA messages determined to have the destination address matching the device address of the receiving device.

Another aspect provides a device for communicating in a system for wireless communication of uncompressed video. The device includes a device address associated with the device, and a wireless communication subsystem to wirelessly transmit and/or wirelessly receive uncompressed video over a high rate channel, and to receive a data packet over a low rate channel, wherein the data packet comprises a header comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses and a data field. The device further includes a decoder to determine if the destination address of one or more MDA messages matches the associated device address, and a processor to process the MDA messages determined to have the destination address matching the associated device address.

Another aspect provides a method of communicating messages between a plurality of devices in a system for wireless communication of uncompressed video. The method includes wirelessly transmitting and/or wirelessly receiving uncompressed video over a high rate channel, encoding a data packet comprising a header comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses, and a data field, and transmitting the encoded data packet over a low rate channel associated with first bandwidth that is smaller than a second bandwidth associated with the high rate channel.

Another aspect provides a device for communicating in a system for wireless communication of uncompressed video. The device includes a wireless communication subsystem to wirelessly transmit and/or wirelessly receive uncompressed video over a high rate channel, and an encoder to encode a data packet comprising a header comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses and a data field, where the wireless communication subsystem transmits the encoded data packet over a low rate channel associated with a first bandwidth that is smaller than a second bandwidth associated with the high rate channel.

### BRIEF DESCRIPTION OF THE DRAWINGS

FIG. 1 is a functional block diagram of a wireless network that implements uncompressed HD video transmission between wireless devices according to one embodiment of the system and method.

FIG. 2 is a functional block diagram of an example communication system for transmission of uncompressed HD video over a wireless medium, according to one embodiment of the system and method.

FIG. 3 is a frequency map of an example of overlapping high rate and low rate channels that may be used in a wireless network such as illustrated in FIG. 1.

FIG. 4 is an illustration of examples of omni-directional and directional channel beams that may be used in a wireless network such as illustrated in FIG. 1.

FIG. 5a is an illustration of a sequence of superframes and a breakdown of an example of a superframe time period that may be used in a wireless network such as illustrated in FIG. 1.

FIG. 5b is an illustration of an example of time division duplexing of the low and high rate channels illustrated in FIG. 3 within a superframe period.

FIG. 6 is a block diagram illustrating an embodiment of a wireless receiver that may be used in a communication system such as illustrated in FIG. 2.

FIG. 7 is a block diagram illustrating an illustrating an embodiment of a wireless transmitter that may be used in a communication system such as illustrated in FIG. 2.

FIG. 8 is a flowchart illustrating an example of a method of receiving multiple destination aggregation messages in a system such as illustrated in FIG. 2.

FIG. 9 is a flowchart illustrating an example of a method of transmitting multiple destination aggregation messages in a system such as illustrated in FIG. 2.

FIG. 10A shows various fields in a multiple data aggregation (MDA) message in one embodiment.

FIG. 10B shows various subfields in a MAC control field of an MDA message such as illustrated in FIG. 10A.

FIG. 11 shows various fields in a low-rate channel data packet including multiple MDA messages in one embodiment.

FIGS. 12a to 12c show various fields of another embodiment of a low-rate channel data packet, a low-rate channel preamble sub-packet, and a low-rate channel header sub-packet, respectively.

### DETAILED DESCRIPTION OF CERTAIN INVENTIVE EMBODIMENTS

Certain embodiments provide a method and system for transmission of uncompressed HD video information from a sender to a receiver over wireless channels.

The following detailed description is directed to certain sample embodiments of the invention. However, the invention can be embodied in a multitude of different ways as defined and covered by the claims. In this description, reference is made to the drawings wherein like parts are designated with like numerals throughout.

Embodiments include systems and methods of data processing in wireless communication devices for communication of uncompressed video data will be described. Video data may include one or more of motion video, still images, or any other suitable type of visual data. Messages using multiple destination aggregation (MDA) on a low-rate channel while uncompressed video is transmitted and/or received on a time division duplexed high-rate channel will also be disclosed. The multiple MDA messages can be communicated to a single receiver device or multiple receiver devices.

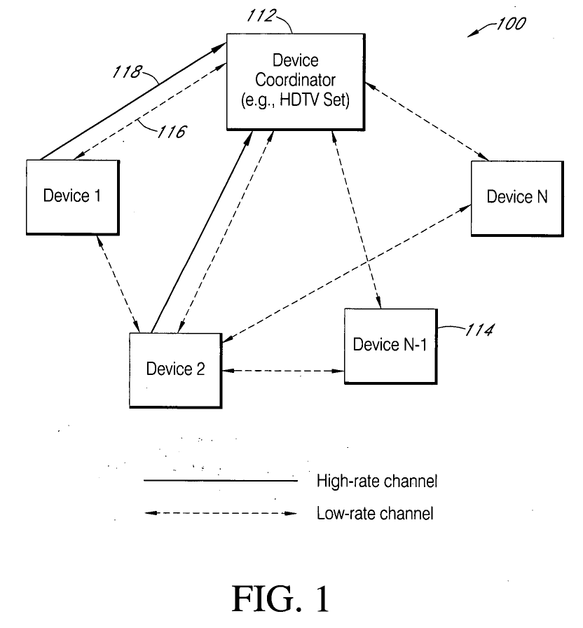

Exemplary implementations of the embodiments in a wireless high definition (HD) audio/video (A/V) system will now be described. FIG. 1 shows a functional block diagram of a wireless network 100 that implements uncompressed HD video transmission between A/V devices such as an A/V device coordinator and A/V stations, according to certain embodiments. In other embodiments, one or more of the devices can be a computer, such as a personal computer (PC). The network 100 includes a device coordinator 112 and multiple client devices or A/V stations 114 (e.g., Device 1 . . . . Device N).

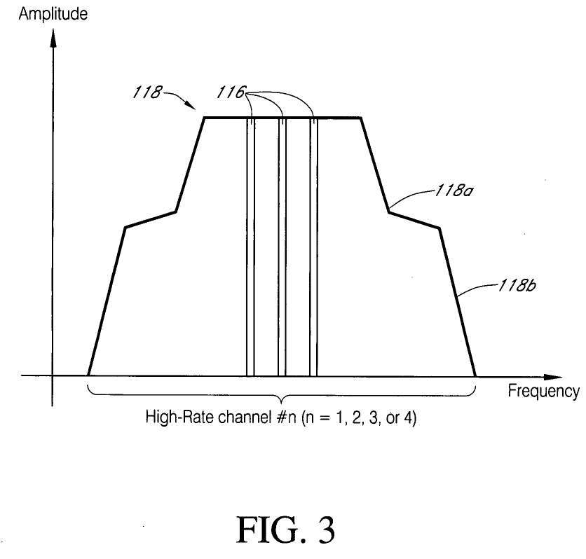

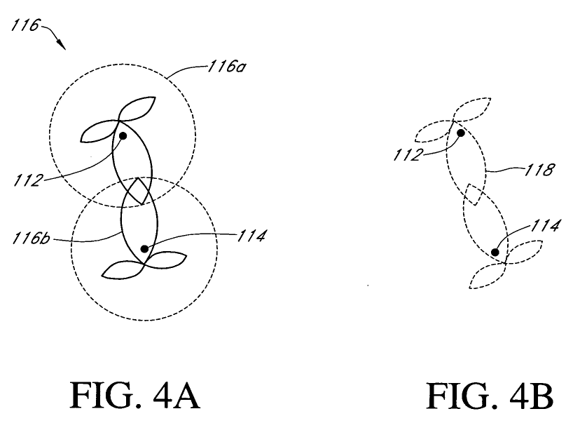

The A/V stations 114 utilize a low-rate (LR) wireless channel 116 (dashed lines in FIG. 1), and may use a high-rate (HR) channel 118 (heavy solid lines in FIG. 1), for communication between any of the devices. The device coordinator 112 uses a low-rate channel 116 and a high-rate wireless channel 118, for communication with the stations 114. Each station 114 uses the low-rate channel 116 for communications with other stations 114. The high-rate channel 118 supports single direction unicast transmission over directional beams established by beamforming, with e.g., multi-GB/s bandwidth, to support uncompressed HD video transmission. For example, a set-top box can transmit uncompressed video to a HD television (HDTV) over the high-rate channel 118. The low-rate channel 116 can support bi-directional transmission, e.g., with up to 40 Mbps throughput in certain embodiments. The low-rate channel 116 is mainly used to transmit control frames such as acknowledgement (ACK) frames. For example, the low-rate channel 116 can transmit an acknowledgement from the HDTV to the set-top box. It is also possible that some low-rate data like audio and compressed video can be transmitted on the low-rate channel between two devices directly. Time division duplexing (TDD) is applied to the high-rate and low-rate channel. At any one time, the low-rate and high-rate channels cannot be used in parallel for transmission, in certain embodiments. Beamforming technology can be used in both low-rate and high-rate channels. The low-rate channels can also support omni-directional transmissions. Details of the low and high-rate channels will be discussed below in reference to FIGS. 3 and 4.

In one example, the device coordinator 112 is a receiver of video information (referred to as “receiver 112”), and the station 114 is a sender of the video information (referred to as “sender 114”). For example, the receiver 112 can be a sink of video and/or audio data implemented, such as, in an HDTV set in a home wireless network environment which is a type of WLAN. The sender 114 can be a source of uncompressed video or audio. Examples of the sender 114 include a set-top box, a DVD player or recorder, a digital camera, a camcorder, and so forth.

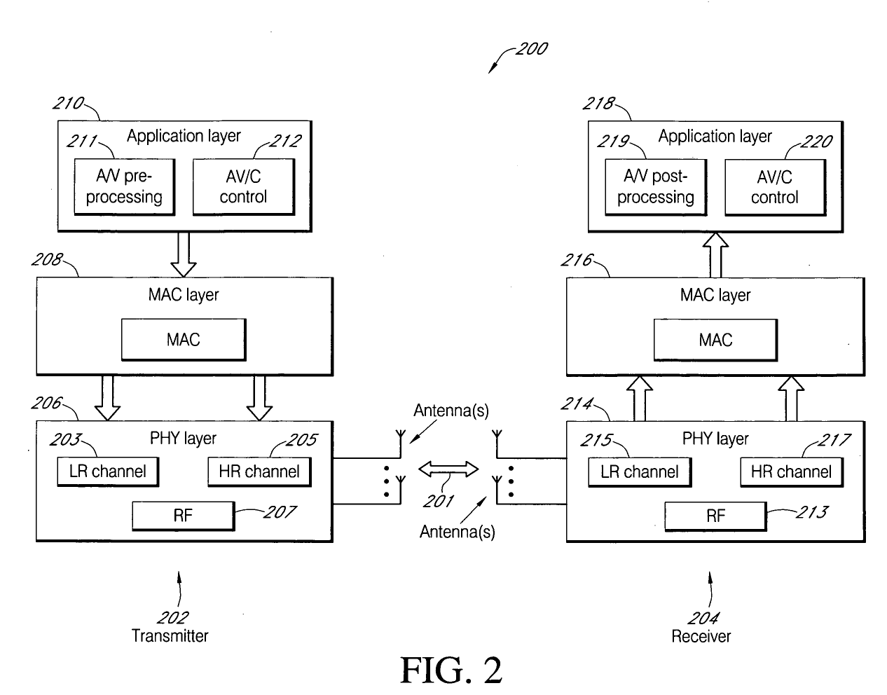

FIG. 2 illustrates a functional block diagram of an example communication system 200. The system 200 includes a wireless transmitter 202 and wireless receiver 204. The transmitter 202 includes a physical (PHY) layer 206, a media access control (MAC) layer 208 and an application layer 210. Similarly, the receiver 204 includes a PHY layer 214, a MAC layer 216, and an application layer 218. The PHY layers provide wireless communication between the transmitter 202 and the receiver 204 via one or more antennas through a wireless medium 201.

The application layer 210 of the transmitter 202 includes an A/V pre-processing module 211 and an audio video control (AV/C) module 212. The A/V pre-processing module 211 can perform pre-processing of the audio/video such as partitioning of uncompressed video. The AV/C module 212 provides a standard way to exchange A/V capability information. Before a connection begins, the AV/C module negotiates the A/V formats to be used, and when the need for the connection is completed, AV/C commands are used to stop the connection.

In the transmitter 202, the PHY layer 206 includes a low-rate (LR) channel 203 and a high rate (HR) channel 205 that are used to communicate with the MAC layer 208 and with a radio frequency (RF) module 207. In certain embodiments, the MAC layer 208 can include a packetization module (not shown). The PHY/MAC layers of the transmitter 202 add PHY and MAC headers to packets and transmit the packets to the receiver 204 over the wireless channel 201.

In the wireless receiver 204, the PHY/MAC layers 214, 216 process the received packets. The PHY layer 214 includes a RF module 213 connected to the one or more antennas. A LR channel 215 and a HR channel 217 are used to communicate with the MAC layer 216 and with the RF module 213. The application layer 218 of the receiver 204 includes an A/V post-processing module 219 and an AV/C module 220. The module 219 can perform an inverse processing method of the module 211 to regenerate the uncompressed video, for example. The AV/C module 220 operates in a complementary way with the AV/C module 212 of the transmitter 202.

As discussed above, the frequency bands of the low-rate and high-rate channels overlap. There may be portions of the high-rate channel that may not overlap with a low-rate channel and conversely, there may be portions of a low-rate channel that do not overlap the high-rate channel, depending on the embodiment. FIG. 3 is a frequency map of an example of overlapping high-rate and low-rate channels that may be used in a wireless network such as illustrated in FIG. 1. In this example, three low-rate channels 116 are positioned within a single high-rate channel 118. There can be more or fewer low-rate channels 116 than three as in this example. The low-rate channels 116 may have a bandwidth in a range from about 50 MHz. to about 200 Mhz, preferably from about 80 MHz to about 100 Mhz

There may also be multiple high-rate channels 118 as indicated by the “channel #n” in FIG. 3. In this example, there are 4 high-rate channels 118. The high-rate channel 118 is shown as having sloping sidebands 118a and 118b. This is done for limiting inter-channel interference between adjacent channels. However, some embodiments may not use sloping sidebands. The low-rate channels 116 may also exhibit sloping sidebands (not shown). The high-rate and low-rate channels may be present in any frequency band. The bandwidth of the high-rate channel used depends on the data rate of the uncompressed video to be communicated. The bandwidth may be large enough to support a data rate in a range from about 1 Gbps to about 4 Gbps. Frequency bands that are used for other wireless systems can be used. The choice of frequency bands may depend on the regulatory agency of the country in which the system is being used. In the United States, for example, four unlicensed device frequency bands are allocated at 800 MHz, 2.4 GHz, 5 GHz and 60 GHz. Any of these may be used in embodiments, preferably the 5 GHz or 60 GHz bands.

FIGS. 4A and 4B are illustrations of examples of omni-directional and directional channel beams that may be used in a wireless network such as illustrated in FIG. 1. FIG. 4a depicts a device coordinator 112 communicating with a client device 114 over a low-rate channel 116. The low-rate channel 116 can be used in either an omni-directional mode, as illustrated by the circular coverage areas 116a, or a directional mode, e.g., using beam steering, as illustrated by the narrow beam coverage areas 116b. In either case, the low-rate channel 116 is a symmetric channel. FIG. 4b depicts a device coordinator 112 and a client device communicating over a high-rate channel 118. The high-rate channel 118 is an asymmetric directional channel as depicted by the narrow beam coverage areas of FIG. 4b. In one embodiment, a directional low rate channel is used in conjunction with the asymmetric directional high rate channel for communication of ACKs, etc., from the data receiving device to the data transmitting device indicating whether the data is successfully received or not.

In one embodiment, the low-rate channel uses OFDM (orthogonal frequency division multiplexing) in both the omni-directional and directional modes. However, any transmission protocol may be used, including, for example, code division multiple access (CDMA) frequency division multiple access (FDMA) system, time division multiple access (TDMA), frequency hopping, etc. The low-rate channel omni-directional mode is used for transmission of control data such as beacon messages (discussed below), network/device association and disassociation, device discovery, acknowledgements, device capability and preference exchanges, etc. The low rate channel directional or beamformed mode can be used for communicating audio signals and/or compressed video signals. The low-rate channel directional mode is not as reliable due to frequently changing channel conditions including blockages by objects such as people, furniture, walls, etc. For this reason, the omni-directional mode is used for the majority of control signals since it is more reliable, covers all directions whereby movement of the receiver and/or transmitter has less effect on the ability to maintain a connection. The low-rate channel omni-directional mode offers data rates in a range from about 2.5 Mbps to about 10 Mbps. The low-rate channel directional mode offers data rates in a range from about 20 Mbps to about 40 Mbps. However, other data rates are envisioned as being possible.

The directional modes of the low-rate and high-rate channels can be used for multiple simultaneous connections between devices since the transmission beams are narrow and may not adversely affect one another. However, the low-rate channel omni-directional transmissions (as depicted by the circular coverage areas 116a in FIG. 4a) can interfere with any device coordinator 112 or client device 114 within range. For this reason, the low-rate channel omni-directional transmissions are time division duplexed with the directional transmissions (both low-rate and high-rate). Time division duplexing of low-rate channel omni-directional transmissions and the high-rate channel directional transmissions will now be discussed.

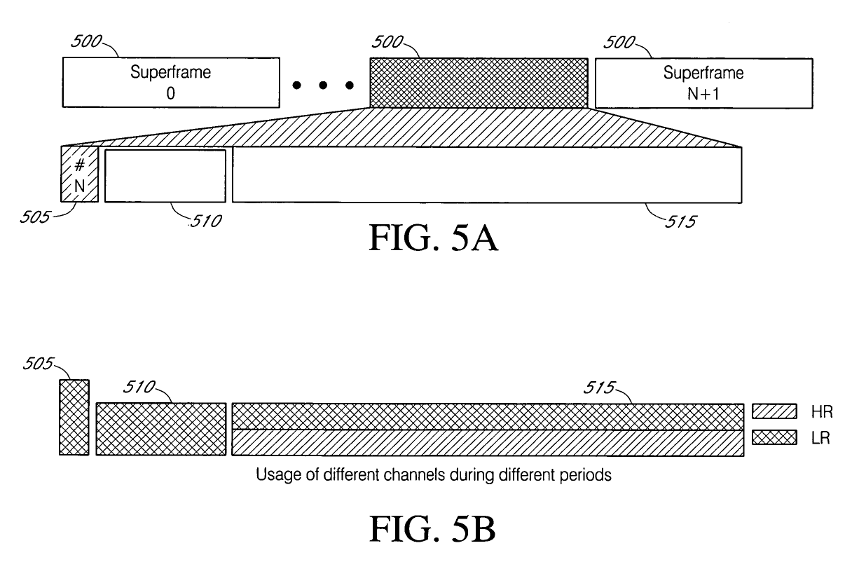

Many time division duplexing (TDD) channel access control schemes known to those in the art can be used to coordinate transmissions of the low-rate and high-rate channels within a network. The goal of the TDD scheme is to only have one of the two channels, low-rate or high-rate, being used for transmission at any one time. An example of a channel access control scheme used to coordinate the low-rate and high-rate channels is a superframe-based scheme. FIG. 5a is an illustration of a sequence of superframes and a breakdown of an example of a superframe time period that may be used in a wireless network such as illustrated in FIG. 1. In a superframe base transmission system, the transmission time is broken into a series of superframes 500. The length of time of the superframe is made small enough to allow for frequent medium access control (this cuts down on delays in processing control signals that enable access), but is made long enough to provide for efficient throughput of uncompressed video data. Large delays in processing user commands, such as on/off, channel switch, volume change, etc., will negatively affect the user experience. For these reasons, a superframe time is typically in a range from about 16 msec. to about 100 msec.

In the example superframe scheme shown in FIG. 5a, each superframe is divided into 3 main time frames, a beacon frame 505, a control period frame 510 and a frame for reserved and unreserved channel time blocks (CTB's) 515. The time frame 515 for reserved and unreserved CTB's is herein referred to as the CTB frame 515. The beacon frame is used to set the timing allocations for the reserved and unreserved CTBs of the CTB frame 515. A device coordinator 112, such as a TV set, for example, communicates reserved time slots to the multiple client devices 114 in a network such as the network 100 in FIG. 1.

The control period frame 510 is used to allow client devices to transmit control messages to a device coordinator. Control messages may include network/device association and disassociation, device discovery, time slot reservations, device capability and preference exchanges, etc. The control period frame 510 may use a contention based access system such as Aloha, slotted Aloha, CSMA (carrier sensed multiple access), etc., to allow multiple devices to send control messages and to handle collisions of messages from multiple devices. When a message from a client device is received at a device coordinator without suffering a collision, the device coordinator can respond to the request of the message in the beacon frame 505 of a subsequent superframe 500. The response may be a time slot reservation of a CTB in one or more subsequent superframes 500.

The CTB frame 515 is used for all other transmissions other than beacon messages and contention based control messages which are transmitted in the beacon frame 505 and the control frame 510. Reserved CTBs are used to transmit commands, isochronous streams and asynchronous data connections. CTB's can be reserved for transmission by a coordinator device to a specific client device, for transmission by a client device to a device coordinator, for transmission by a client device to another client device, etc. A CTB can be used to transmit a single data packet or multiple data packets. A CTB frame can include any number of reserved or unreserved CTB's. Unreserved CTB's in the CTB frame 510 can be used for communication of further contention based commands on the low-rate channel such as remote control commands (e.g., CEC and AVC commands), MAC control, and management commands.

It is desirable to make the length of the control frame 510 as small as possible while still allowing many client devices to be able to successfully access the network without undue time delay, e.g., due to message collision. In one embodiment, the only messages that are sent on a contention basis are control initiation request messages that identify a requesting device and a type of message sequence exchange to be scheduled in a reserved CTB. In this way, the size of the messages that are contention based are kept to a minimum. All other message exchanges on the low-rate channel can be scheduled.

In order for a message of a client device to be identified by a receiving device coordinator, a preamble is used at the start of a contention based message. The preamble is a predetermined bit sequence that can be identified by the device coordinator (or any receiving device). Carrier sensing is particularly difficult in the 60 GHz frequency range and the length of the preamble may be in a range from about 30 microsec. to about 75 microsec. Such long preambles make it very difficult to keep the control frame 510 to a desired short time duration. It can be envisioned that with many client devices, there could be a large number of collisions occurring in the control period 510, especially if the data being communicated is large, such as in a device capability message. Therefore, an efficient method of processing control messages is needed. In embodiments where the preamble is in a range from about 30 microsec to about 75 microsec., the length of the control frame 510 may be in a range from about 100 to about 600 microsec.

FIG. 5b is an illustration of an example of time division duplexing of the low and high rate channels illustrated in FIG. 3 within a superframe period. FIG. 5b shows which channels can be used for transmission in the various superframe sub-frames shown in FIG. 5a. In one embodiment, only the low-rate channel 116 is used for transmission during the beacon frame 505, and the control frame 510. Both the high-rate and low-rate channels can be used for transmission during the CTB frame 515. Any of the beacon frame 505, the control frame 510 and the CTB frame 515 can have either fixed or variable durations, depending on the embodiment. Likewise, the superframe 500 time duration can be fixed or variable, depending on the embodiment.

As discussed above, carrier sensing of wireless transmissions in certain frequency spectrum (e.g., the 60 GHz spectrum) may require long duration preambles on the order of 30 microsec. to 75 microsec. or more when using the omnidirectional mode as is used for control message communication on the low-rate channels 116. Since the time of use of the low-rate channel 116 directly impacts the amount of time that the more efficient time division duplexed high-rate channel can be used, it is desirable to have transmission on the low-rate channels as efficient as possible. In general, the control data packets (e.g., ACKs, MAC commands, and AVC commands, etc.) that are transmitted over the low-rate channel 116 in omni-directional mode are very small, which increases the inefficiency of the corresponding data packets due to the large preamble. One method of improving the efficiency of messages transmitted containing a large preamble is to increase the size of the data unit compared to the overhead data including the preamble, header and other overhead data. By aggregating multiple control messages into a single packet (including a single preamble), the ratio of data information to overhead information is increased, which increases the efficiency. In addition to aggregating multiple messages directed to a single destination device, aggregating multiple messages directed to multiple destination devices into a single data packet can further increase the efficiency of the low-rate channel transmissions. Details of processing multiple destination aggregation (MDA) messages will now be discussed.

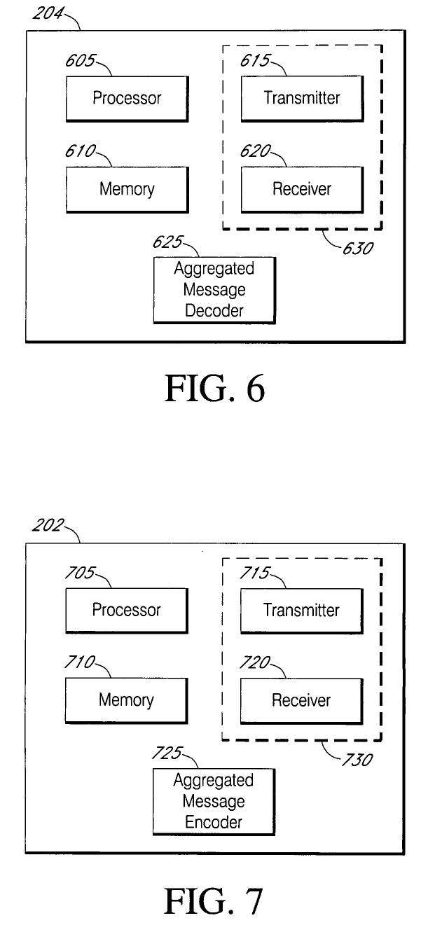

FIG. 6 is a block diagram illustrating an embodiment of the wireless receiver 204 that may be used in the communication system 200 as illustrated in FIG. 2. In this embodiment, the wireless receiver 204 is configured to receive MDA messages communicated to multiple wireless receivers 204. The wireless receiver 204 comprises a processor element 605, a memory element 610, a receiver element 615, a transmitter element 620, and an aggregated message decoder 625. The transmitter 610 and the receiver 615 may be referred to collectively as a wireless communication subsystem 630. The processor 605 may include one or more of a general purpose processor and/or a digital signal processor and/or an application specific hardware processor. The memory 610 may include, for example, one or more of integrated circuits or disk based storage or any readable and writeable random access memory device. The processor 605 is coupled to the memory 610 and the other elements to perform the various actions of the other elements. In reference to FIG. 1, the receiver 615 receives data transmitted by other devices in the network 100, such as the client devices 114 and the device coordinator 112. The receiver can be configured to receive data over the low-rate channel 116 and/or the high rate channel 118. The transmitter 620 transmits data over the network 100. The transmitter 620 can be configured to transmit over the low-rate channel only as depicted in the device coordinator 112 in the network 100 of FIG. 1, or to transmit over the high-rate channel 118 as well, for example to a digital video recorder device (not shown).

The aggregated message decoder 625 processes MDA messages received by the receiver 630 that have been communicated to the wireless receiver 204. The processing of the MDA messages may include destination determination, decoding, de-packetization and more. The aggregated message decoder 625 may be part of the MAC Layer 216 shown in FIG. 2. The processing performed by the aggregated message decoder 625 may also include functions of various application layer modules of the wireless receiver 204 such as the A/V post-processing module 219, and the AV/C control module 220 of FIG. 2.

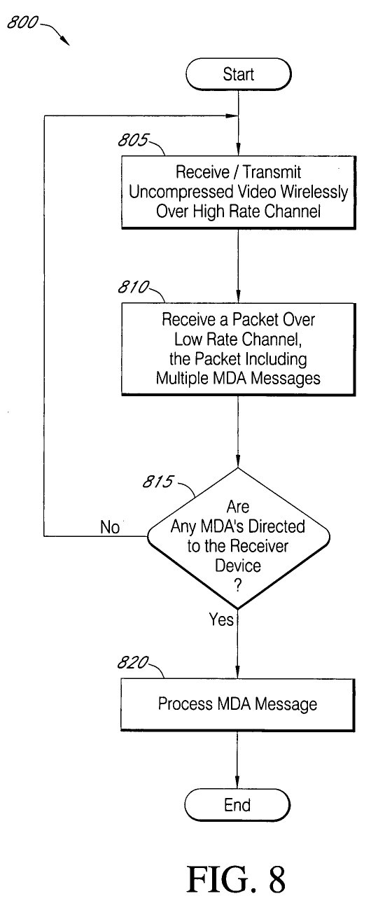

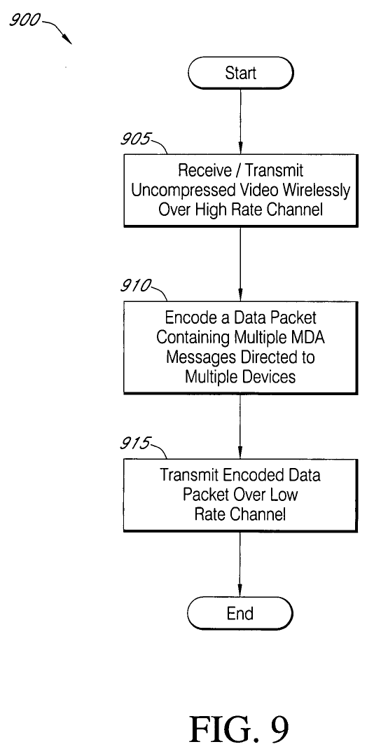

In some embodiments, one or more of the elements of the wireless receiver 204 of FIG. 6 may be rearranged and/or combined. The elements may be implemented by hardware, software, firmware, middleware, microcode or any combination thereof. Details of the actions performed by the elements of the wireless receiver 204 will be discussed in reference to the methods illustrated in FIGS. 8 and 9 below.

FIG. 7 is a block diagram illustrating an aspect of the wireless transmitter 202 that may be used in the communication system 200 as illustrated in FIG. 2. In this aspect, the wireless transmitter 202 is configured to transmit MDA messages directed to multiple wireless receivers 204. In this aspect, the wireless transmitter 202 comprises a processor element 705, a memory element 710, a receiver element 715, a transmitter element 720, and an aggregated message encoder element 725. The transmitter 710 and the receiver 715 may be referred to collectively as a wireless communicator 730. The processor 705 may include one or more of a general purpose processor and/or a digital signal processor and/or an application specific hardware processor. The memory 710 may include, for example, one or more of integrated circuits or disk based storage or any readable and writeable random access memory device. The processor 705 is coupled to the memory 710 and the other elements to perform the various actions of the other elements. The receiver 715 receives data transmitted by other devices in the network 100, such as the device coordinator 112 or other client devices 114. The receiver 715 can be configured to receive data over the low-rate channel 116 and/or the high rate channel 118. The transmitter 720 transmits data over the network 100. The transmitter 720 can be configured to transmit over the low-rate channel only as depicted in the client device labeled Device N in the network 100 of FIG. 1, or to transmit over both the low-rate channel 116 and the high-rate channel 118 as in the client device labeled Device 2.

The aggregated message encoder 725 processes MDA messages to be transmitted by the transmitter 715 and communicated to multiple wireless receivers 204 in the communication system 200. The processing of the MDA messages may include destination determination, encoding, packetization and more. The aggregated message encoder 725 may be part of the MAC Layer 208 shown in FIG. 2. The processing performed by the aggregated message encoder 725 may include functions of various application layer modules of the wireless transmitter 202 such as the A/V pre-processing module 211, and the AV/C control module 212 of FIG. 2.

In some embodiments, one or more of the elements of the wireless transmitter 202 of FIG. 7 may be rearranged and/or combined. The elements may be implemented by hardware, software, firmware, middleware, microcode or any combination thereof. Details of the actions performed by the elements of the wireless transmitter 202 will be discussed in reference to the methods illustrated in FIGS. 8 and 9 below.

FIG. 8 is a flowchart illustrating an example of a method of receiving multiple destination aggregation messages in a system such as illustrated in FIG. 2. Process 800 includes functions that are performed by a wireless receiver device such as the wireless receiver 204 in FIG. 2. The process 800 enables the wireless receiver 204 to receive MDA messages on the low-rate channel 116 and to process the MDA messages that are targeted to the wireless receiver 204 while discarding MDA messages that are targeted to other devices in the network 100. The method 800 provides an efficient method for receiving control messages in the MDA messages over the low-rate channel 116 while the wireless device performing the process 800 transmits and/or receives uncompressed video over the high-rate channel 118 on a time division duplexed basis as discussed above.

The process 800 starts at block 805 where the wireless receiver 204 transmits and/or receives uncompressed video over the high-rate channel 118. If the wireless receiver 204 is contained in a device coordinator 112, then the wireless receiver 204 may receive uncompressed video over the high-rate channel 118. However, if the wireless receiver 204 is contained in a client device 114, then the wireless receiver 204 may transmit uncompressed video over the high rate channel. In some embodiments the wireless receiver 204 performing the process 800 may transmit and receive uncompressed video over the high-rate channel (e.g., an HDTV receiving from a set top box and transmitting to a digital video recorder). The wireless communicator 630 of the wireless receiver 204 shown in FIG. 6 may perform the functionality of block 805. More specifically, the receiver element 620 receives the uncompressed video and the transmitter element 615 transmits the uncompressed video at the block 805.

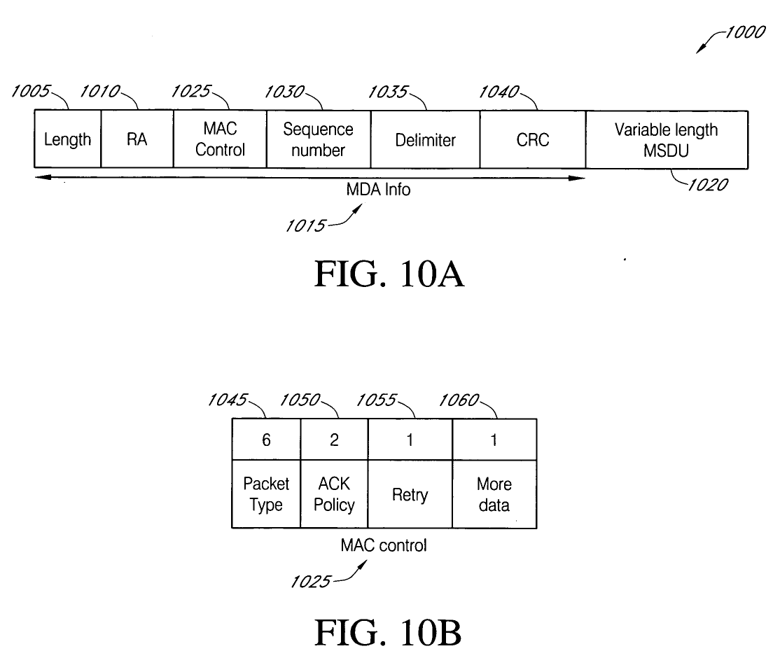

When the wireless receiver 204 is not transmitting and/or receiving uncompressed video over the high-rate channel 118 at block 805, the wireless receiver 204 can receive a data packet over the low-rate channel 116 at block 810, the data packet includes multiple MDA messages targeted to one or more destination devices. The data packet containing the MDA messages (referred to henceforth as the MDA packet) can be received over the low-rate channel 116 in any of the time frames of the superframe 500 shown in FIG. 5 including the beacon frame 505, the control frame 510 and the CTB frame 515 including both reserved time blocks and unreserved time blocks. The received MDA data packet can be received from any of the devices in the network 100 including device coordinators 112 and client devices 114. Details of the format of the MDA packet and the MDA messages contained in the packet will be discussed below in reference to FIGS. 10, 11 and 12. The receiver element 620 of the wireless receiver 204 in FIG. 6 can perform the functionality of the block 810.

Subsequent to receiving the MDA packet at the block 810, the wireless receiver 204 determines at decision block 815 if any of the plurality of MDA messages contained in the MDA packet are directed to the wireless receiver 204. Generally, each MDA message will contain a field identifying a receiver address of the device that the MDA message is directed to. If it is determined at the decision block 815 that none of the MDA messages is directed to the wireless receiver 204, the process 800 returns to block 805 to receive and/or transmit more uncompressed video over the high rate channel. If it is determined at the decision block that one or more of the MDA messages is directed to the wireless receiver 204, the process 800 continues to block 820. The aggregated message decoder element 625 of the wireless receiver 204 shown in FIG. 6 can perform the functionality at the decision block 815.

When MDA messages received in the MDA packet at the block 810 are determined to be targeted to the wireless receiver 204, these targeted MDA messages are processed at the block 820. Processing of the MDA messages can include de-packetization, decoding and routing sub-packets to various application layer components. The various MDA messages may include ACKs, e.g., from a coordinator device acknowledging receipt of uncompressed video frames transmitted by the wireless receiver 204 at the block 805. The MDA messages may contain other control messages such as responses or requests including beacon messages containing reserved CTB information from a device coordinator, network/device association and disassociation messages, device discovery messages, device capability and preference exchange messages, etc. Referring to FIG. 6, the aggregated messages decoder element 625 can perform the functionality related to de-packetization and decoding at the block 820 while the processor 605 can perform processing related to other modules such as application modules.

Thus the process 800 provides an efficient method for a wireless receiver 204 (in a device coordinator 112 or a client device 114) to receive control messages, at block 810, from a plurality of other devices in the network 100. Since only a single LRC preamble and header are contained in the MDA packet containing multiple MDA messages targeted at multiple receiver devices, the efficiency of the low-rate channel 116 is improved. By improving the efficiency of messages transmitted over the low-rate channel 116, more time is given to transmit on the time division duplexed high-rate channel 118 which has a much higher data throughput rate. It should be noted that some of the blocks of the process 800 may be combined, omitted, rearranged or any combination thereof.

FIG. 9 is a flowchart illustrating an example of a method of transmitting multiple destination aggregation messages in a system such as illustrated in FIG. 2. Process 900 includes functions that are performed by a wireless transmitter device such as the wireless transmitter 202 in FIG. 2. The process 900 enables the wireless transmitter 202 to encode and transmit data packets containing multiple MDA messages on the low-rate channel 116 where the MDA messages are targeted to multiple wireless devices in the network 100. The process 900 provides an efficient method for transmitting control and/or network management messages in the MDA messages over the low-rate channel 116 while the wireless device performing the process 900 transmits and/or receives uncompressed video over the high-rate channel 118 on a time division duplexed basis as discussed above.

The process 900 starts at block 905 where the wireless transmitter 202 transmits and/or receives uncompressed video over the high-rate channel 118. If the wireless transmitter 202 is contained in a device coordinator 112, then the wireless transmitter 202 may transmit uncompressed video over the high-rate channel 118. However, if the wireless transmitter 202 is contained in a client device 114, then the wireless transmitter 202 may transmit uncompressed video over the high rate channel. In some embodiments the wireless transmitter 204 performing the process 900 may transmit and receive uncompressed video over the high-rate channel (e.g., an HDTV receiving from a set top box and transmitting to a digital video recorder). The wireless communicator 730 of the wireless transmitter 202 shown in FIG. 7 may perform the functionality of block 905. More specifically, the receiver element 720 receives the uncompressed video and the transmitter element 715 transmits the uncompressed video at the block 905.

The process 900 continues to block 910 where the wireless transmitter 202 encodes a data packet containing multiple MDA messages that can be targeted to multiple receiving devices such as device coordinators 112 or client devices 114. Generally, each encoded MDA message will contain a field identifying a receiver address of the device that the MDA message is directed to. The MDA messages that are encoded at the block 910 may include, for example, ACKs, MAC commends and AVC commands to send in response to receiving messages over the low-rate channel 116 and/or the high-rate channel 118. The MDA messages may also contain other control messages such as responses or requests including beacon messages containing reserved CTB information from a device coordinator, network/device association and disassociation messages, device discovery messages, device capability and preference exchange messages, etc. The aggregated message encoder element 725 of the wireless transmitter 202 shown in FIG. 7 can perform the functionality at the block 910.

When the wireless transmitter 202 is not transmitting and/or receiving uncompressed video over the high-rate channel 118 at block 905, the wireless transmitter 202 can transmit an MDA packet over the low-rate channel 116 at block 915, the MDA packet including multiple MDA messages targeted to one or more destination devices. The MDA packet can be transmitted over the low-rate channel in any of the time frames of the superframe 500 shown in FIG. 5 including the beacon frame 505, the control frame 510 and the CTB frame 515. The transmitted MDA data packet can be transmitted to any of the devices in the network 100 including device coordinators 112 and client devices 114. Details of the format of the MDA packet and the MDA messages contained in the packet will be discussed below in reference to FIGS. 10, 11 and 12. The transmitter element 720 of the wireless transmitter 202 in FIG. 7 can perform the acts of the block 915.

Thus the process 900 provides an efficient method for a wireless transmitter 202 (in a device coordinator 112 or a client device 114) to transmit control messages, at block 915, to a plurality of wireless receiver devices in the network 100. Since only a single LRC preamble and header are contained in the MDA packet containing multiple MDA messages targeted at multiple receiver devices, the efficiency of the low-rate channel 116 is improved. By improving the efficiency of messages transmitted over the low-rate channel 116, more time is given to transmit on the time division duplexed high-rate channel 118 which has a much higher data throughput rate. It should be noted that some of the blocks of the process 900 may be combined, omitted, rearranged or any combination thereof.

FIG. 10A shows various fields in a multiple data aggregation (MDA) message. The MDA message 1000 in this example includes several fields. A group of fields known as the MDA information field 1015 includes six subfields including, a length field 1005, a receiver address (RA) field 1010, a MAC control field 1025, a sequence number field 1030, a delimiter field 1035 and a CRC (cyclic redundancy check) field 0140. The MDA message 1000 also includes a data field known as a MAC service data unit (MSDU) field 1020. In some embodiments, the length field 1005 is a fixed length field that is set to a value indicating the length (in bits or bytes depending on the embodiment) other fields in the MDA information field 1015 and the MSDU field 1020 are combined. In other embodiments, the MDA information field is a fixed length field and the length field 1005 is set to a value indicating the length of the MSDU field only. In still other embodiments, all the fields of the MDA information field 1015 and the MSDU field 1020 are fixed length fields and the length field 1005 may be omitted. In yet another embodiment, these fields can be rearranged in a different order. In one embodiment, the delimiter field 1035 can be the first field in the MDA info field 1015. The CRC field 1040 can be placed after the MSDU such that the CRC is calculated over the all fields except the delimiter.

The MAC control field may include one or more subfields. FIG. 10B shows various subfields in the MAC control field 1025 of the MDA message 1000 such as illustrated in FIG. 10A. In this example, the MAC control field 1025 includes a packet type field 1045, an acknowledgement (ACK) policy field 1050, a retry bit 1055, and a more-data bit 1060. The packet type field 1045 may be used to indicate a type of data packet to assist in the processing of the data packet at a receiving device. The ACK policy field 1050 may be used to indicate the ACK policy for the packet. The ACK policy may be any of those know to skilled technologists. In one embodiments, a coordinator device may explicitly schedule reserved time periods for the multiple receiving devices to transmit the ACK messages. In another embodiments the coordinator does not explicitly indicate separate time periods for multiple receivers, but instead reserves one larger time period to accommodate reception of ACK messages from all receivers. In this embodiment, a receiver device generates an ACK packet in the order that the corresponding MSDU appeared in the received MDA message 1000. The first MSDU can be categorized after decoding the MAC control field. Since a receiver device can determine its position in the ACK sequence to be transmitted by the MDA receivers, the receiver can implicitly estimate the time when to transmit the ACK. It can be assumed that ACK messages are of fixed length and each takes a fixed amount of time to transmit. The fixed amount of time may include an ACK transmit time and an inter-frame space (referred to as Sifs as used in IEEE 802.11). The Sifs period may include time for propagation delay, MAC processing delay and Rx to Tx turnaround delay. If there are three MSDU's 1020 (along with corresponding MDA information fields 1015) in an MDA message, for example, then the first receiving device for the first MSDU will transmit its ACK at the beginning of the ACK transmit period, the second receiving device for the second MSDU will transmit after the fixed ACK time (Sifs+ACK transmit duration time) and the third receiving device will transmit its ACK after two fixed time periods (2*Sifs+2*ACK transmit duration). The retry bit 1055 is set to a value of one, for example, if the packet is either a data packet or MAC command packet and the packet is a retransmission of a previously transmitted packet. Otherwise the retry bit is set to zero. The more-data bit 1060 is set to a value of one, for example, if a device is not going to send any more data packets in a time period, otherwise it is set to zero.

Referring to FIG. 10A, the sequence number field 1030 indicates the number of the MSDU field 1020 which could be a sequential number between zero and N in a sequence of MSDUs where the sequence number wraps around when the maximum value is reached. The delimiter field 1035 may be set to some pre-determined string which is used to recover correct MSDU fields 1020 in the event of bit errors occur in the MDA information field 1015. For example, if a first MSDU field 1020 is in error, as detected by comparison of the CRC field 1040 with a calculated CRC at the receiver, the receiver can search for a next delimiter field 1035 in the bitstream in order to identify the next MDA information field 1015 (e.g., the delimiter field 1035 may be the first filed in the MDA information field 1015). In another example, the next two delimiter fields after an erroneous MSDU 1020 may be located to identify the next MSDU 1020 between the two delimiter fields 1035. The CRC field 1040 carries information having bits which are computed and used to produce a checksum against the MDA information field 1015. The checksum is used to detect errors in the MDA information field 1015 after transmission. The CRC is computed and filled in the CRC field 1040 by the transmitter and verified afterwards by the receiving device to confirm that no errors occurred during the transmission. The CRC field may be computed using any CRC known by skilled technologists such as, for example, the IEEE 802.11 standards; CRC-16 or CRC-32.

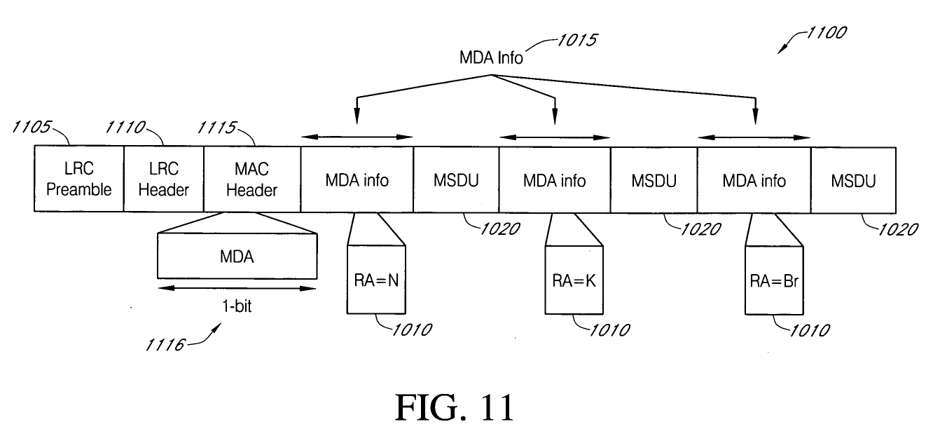

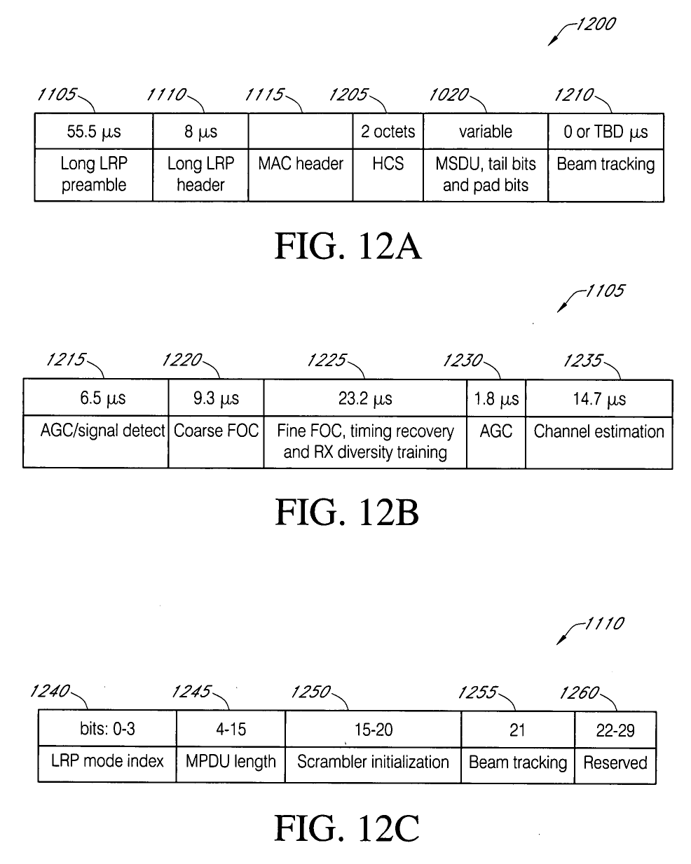

FIG. 11 shows various fields in a low-rate channel data packet including multiple MDA messages 1000 as illustrated in FIG. 10. The data packet 1100 of this example includes 3 MDA messages 1000 including three MDA information fields 1015 and three MSDU fields 1020. The number of MDA messages 1000 contained in the data packet 1100 can be any integer value greater than one, three is only used as an example. The first two MDA messages 1000 in this example are directed to two different receiver devices as indicated by the receiver address field 1 values of N, and K. The receiver address values N and K are only illustrative examples. Some MDA messages may be broadcast messages that are directed to all devices in a network. The third MDA message 1000 in the data packet 1100 is such a broadcast message as indicated by the “Br” value in the receiver address field 1010. The data packet 1100 also contains a low-rate channel packet preamble (LRP Preamble) field 1105, an LRP header field 1110 and a MAC header field 1115. Details of the LRP preamble 1105 and the LRP header 1110 will be discussed below in reference to FIG. 12. The MAC header field may contain various fields including a source address (not shown), multiple destination addresses (optional but may be needed to remain standard compliant in some embodiments), a length field, a MAC header checksum field and other fields known to those of skill in the art. The MAC header also contains an MDA indication field 1115 used to indicate if multiple MDA messages 1000 are contained in the data packet 1100. In the example data packet 1100, the MDA indication field 1116 comprises a single bit which is indicated in the MAC header. The bit of the indication field 1116 is set to zero, when only a single data field (an MSDU) is attached to the packet. The indication field 1116 bit is set to 1 if there are multiple MDA messages 1000 attached to the data packet 1100. It should be noted that various fields of the MDA message 1000, and the data packet 1100 can be combined, omitted, rearranged or any combination thereof.

In some embodiments, the LRP header field 1110 also includes a length field (see the MPDU length field 1245 of the LRP header 1110 shown in FIG. 12c and discussed below). In these embodiments, the length field 1005 of the last MDA message in the data packet 1100 may be omitted since the length of the last MDA message can be computed simply by subtracting the lengths of the other MDA messages from the total length contained in the field 1245. In other embodiments, the size of the length field 1005 can be reduced as follows. Assuming the length field 1005 is normally 12 bits. If most of the time, the length field 1005 can be represented by fewer than six bits, then the MSB (most significant bit), when set equal to one, indicates that the length field is six bits (including the first bit). When the MSB is set to zero, the length field is 12 bits (including the first bit). Thus, the size of the average length field is reduced by using the MSB to signal the size of the length field bits.

FIGS. 12a to 12c show various fields of another embodiment of a low-rate channel data packet, a low-rate channel preamble sub-packet, and a low-rate channel header sub-packet, respectively. Data packet 1200 is an example of a data packet for transmission over a 60 GHz channel. Some of the various fields include estimates of the length of time to transmit the fields over the low-rate channel 116. The data packet 1200 includes some of the same fields as the data packet 1100 in FIG. 11, such as the LRP preamble 1105, the LRP header 1110, the MAC header 1115 and the MSDU 1020. In this example, the MSDU 1020 is a single MSDU, but could be replaced by multiple MDA messages 1000 including the MDA information 1015 and the MSDU 1020. The data packet 1200 also includes a header check sum (HCS) field 1205 used as an integrity check to indicate if the header information (fields 1105, 1110 and 1115 in this example) was received correctly. The data packet 1200 also includes a Beam tracking field 1210 used for the purpose of steering a directional beam antenna. In this example, the LRP preamble 1105 is 55.5 microsec. in duration and the LRP header 1110 is 8 microsec. in duration. These are typical values for data packets transmitted in the 60 GHz frequency range. The combined time of 63.5 microsec. of overhead for the preamble and the header are an indication of why aggregation of multiple messages is desirable.

The sub-fields of the LRP preamble 1105, and the corresponding transmission time estimates for a 60 GHz frequency range, are shown in FIG. 12b. The LRP preamble field 1105 is used for frequency synchronization between devices and allows stations receiving it is to adjust their transmit frequencies and/or symbol rates to remain synchronized. The sub-fields of the LRP preamble field 1105 include the AGC/signal detect field 1215 for establishing automatic gain control (AGC), the Coarse FOC field 1220 for compensating frequency shifts, the Fine FOC field 1225 including timing recovery and RX diversity training components for finer frequency shift compensation, the AGC field 1230 and the Channel Estimation field 1235. The purposes of these fields are known to skilled technologists and are beyond the scope of this description.

The sub-fields of the LRP header 1110 are shown in FIG. 12c. A 4 bit LRP mode index field 1240 indicates the modulation that is used for the MPDU, where an MPDU or MAC Protocol Data Unit is made up of an MSDU 1020 and a header. A 12 bit MPDU length field 1245 contains the length of the attached MPDU. In the case where the attached MPDU comprises a plurality of MDA messages 1000, the MPDU length field 1245 contains the total length of all the attached MDA messages. In some embodiments, the length field for the last MDA message in the data packet (see field 1005 in the MDA message 1000 in FIG. 10 and the data packet 1100 in FIG. 11) may be omitted since the length of the last MDA message can be computed by subtracting the lengths of the other MDA messages from the total length contained in the field 1245. A 5 bit scrambler initialization field 1250 contains the initial state of the scrambler, where scramblers are typically used to randomize noise in the bitstream. The one bit beam tracking field 1255 is used to indicate if beam tracking information 1210 is contained in the data packet 1200 (it will be set to one if beam tracking information is present, and set to zero otherwise). The reserved bits 1260 can be used for other features not contemplated yet.

The size and transmit duration of the overhead fields (fields other than the MSDU field 1020) shown in FIGS. 12a to 12c give an indication of why MDA messages can yield more efficient message communication over the low-rate channel 116. The fields shown in FIG. 12 are only examples and the fields may be combined, omitted, rearranged or any combination thereof.

One disclosed embodiment is an apparatus for communicating in a system for wireless communication of uncompressed video. The apparatus of this embodiment includes means for wirelessly transmitting and/or wirelessly receiving uncompressed video over a high rate channel, and means for receiving a data packet over a low rate channel, the data packet comprising a header comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses and a data field. The apparatus further includes means for determining if the destination address of one or more MDA messages identifies the apparatus, and means for processing one of the MDA messages determined to have the destination address identifying the apparatus. With reference to FIG. 6, aspects of this embodiment include where the communication means is the wireless communication subsystem 630, where the receiving means is the receiver element 620, where the determining means is the aggregated message decoder element 625 and where the processing means is the processor element 605.

Another disclosed embodiment is an apparatus for communicating in a system for wireless communication of uncompressed video. The apparatus of this embodiment includes communication means for wirelessly transmitting and/or wirelessly receiving uncompressed video over a high rate channel, and means for encoding a data packet comprising a header comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses, and a data field, where the communication means transmits the encoded data packet over a low rate channel associated with first bandwidth that is smaller than a second bandwidth associated with the high rate channel. With reference to FIG. 7, aspects of this embodiment include where the communication means is the wireless communication subsystem 730 and where the encoding means is the aggregated message encoder element 725.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method of communicating messages between a plurality of devices in a system for wireless communication of uncompressed video, the method comprising:
wirelessly transmitting and/or wirelessly receiving uncompressed video over a high rate channel;
receiving a data packet over a low rate channel at a receiving device, the receiving device being identified by a device address, the data packet comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses and a data field;
determining if the destination address of one or more MDA messages matches the device address of the receiving device; and
processing MDA messages determined to have the destination address matching the device address of the receiving device.

2. The method of claim 1, wherein frequency bands of the low and high rate channels at least partially overlap.

3. The method of claim 1, wherein the low and high rate channels use one or more of TDD (time division duplexing), FDMA (frequency division multiple access) and CDMA (code division multiple access).

4. The method of claim 1, wherein the data packet further comprises a preamble comprising a predetermined bit pattern.

5. The method of claim 4, wherein the preamble is characterized by having a duration in a range of about 40 microsec. to about 60 microsec.

6. The method of claim 2, wherein the frequency band of the high rate channel is within a range of frequencies from about 57 GHz to about 66 GHz.

7. The method of claim 1, wherein the plurality of MDA messages in the received data packet comprise information identifying time slot information associated with a plurality of devices, wherein the time slot information represents reserved time periods, within a superframe period of a predetermined length, for the plurality of devices to receive or transmit on at least one of the low rate and the high rate channels.

8. The method of claim 1, the plurality of information fields further including one or more of a packet type field, an acknowledgement policy field, a field used to indicate that a packet is a retransmission of a previously transmitted packet, a field used to indicate if more data packets are to be transmitted within a time period, a sequence number field, a delimiter field set to a pre-determined string, and a cyclic redundancy check field.

9. The method of claim 1, further comprising:
implicitly determining a time to transmit an acknowledgement message for one of the MDA messages determined to have the destination address matching the device address of the receiving device, the time to transmit being determined based on the order in which the MDA messages were received; and
transmitting an acknowledgement message for the MDA message at the determined time.

10. The method of claim 1, wherein the plurality of information fields further comprises a delimiter field comprising a known bit pattern and located at a predetermined location relative to the one of the plurality of MDA messages, the method further comprising locating the delimiter field to thereby locate one of the MDA messages.

11. A system for communicating in a network for wireless communication of uncompressed video, the device comprising:
a device address associated with the device;
a wireless communication subsystem to wirelessly transmit and/or wirelessly receive uncompressed video over a high rate channel, and to receive a data packet over a low rate channel, wherein the data packet comprises a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses and a data field;
a decoder to determine if the destination address of one or more MDA messages matches the associated device address; and
a processor to process the MDA messages determined to have the destination address matching the associated device address.

12. The system of claim 11, wherein frequency bands of the low and high rate channels at least partially overlap.

13. The method of claim 11, wherein the low and high rate channels use one or more of TDD (time division duplexing), FDMA (frequency division multiple access) and CDMA (code division multiple access).

14. The system of claim 11, wherein the data packet further comprises a preamble comprising a predetermined bit pattern.

15. The system of claim 14, wherein the preamble is characterized by having a duration in a range of about 40 microsec. to about 60 microsec.

16. The system of claim 12, wherein the frequency band of the high rate channel is within a range of frequencies from about 57 GHz to about 66 GHz.

17. The system of claim 11, wherein the plurality of MDA messages in the received data packet comprise information identifying time slot information associated with a plurality of devices, wherein the time slot information represents reserved time periods, within a superframe period of a predetermined length, for the plurality of devices to receive or transmit on at least one of the low rate and the high rate channels.

18. The system of claim 11, the plurality of information fields further including one or more of a packet type field, an acknowledgement policy field, a field used to indicate that a packet is a retransmission of a previously transmitted packet, a field used to indicate if more data packets are to be transmitted within a time period, a sequence number field, a delimiter field set to a pre-determined string, and a cyclic redundancy check field.

19. A system for communicating in a network for wireless communication of uncompressed video, the apparatus comprising:
communication means for wirelessly transmitting and/or wirelessly receiving uncompressed video over a high rate channel;
means for receiving a data packet over a low rate channel, the data packet comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses and a data field;
means for determining if the destination address of one or more MDA messages identifies the apparatus; and
means for processing one of the MDA messages determined to have the destination address identifying the apparatus.

20. A method of communicating messages between a plurality of devices in a system for wireless communication of uncompressed video, the method comprising:
wirelessly transmitting and/or wirelessly receiving uncompressed video over a high rate channel;
encoding a data packet comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses, and a data field; and
transmitting the encoded data packet over a low rate channel associated with first bandwidth that is smaller than a second bandwidth associated with the high rate channel.

21. The method of claim 20, wherein frequency bands of the low and high rate channels at least partially overlap.

22. The method of claim 20, wherein the low and high rate channels use one or more of TDD (time division duplexing), FDMA (frequency division multiple access) and CDMA (code division multiple access).

23. The method of claim 20, wherein the data packet further comprises a preamble comprising a predetermined bit pattern.

24. The method of claim 23, wherein the preamble is characterized by having a duration in a range of about 40 microsec. to about 60 microsec.

25. The method of claim 21, wherein the frequency band of the high rate channel is within a range of frequencies from about 57 GHz to about 66 GHz.

26. The method of claim 20, wherein the plurality of MDA messages in the received data packet comprise information identifying time slot information associated with a plurality of devices, wherein the time slot information represents reserved time periods, within a superframe period of a predetermined length, for the plurality of devices to receive or transmit on at least one of the low rate and the high rate channels.

27. The method of claim 20, the plurality of information fields further including one or more of a packet type field, an acknowledgement policy field, a field used to indicate that a packet is a retransmission of a previously transmitted packet, a field used to indicate if more data packets are to be transmitted within a time period, a sequence number field, a delimiter field set to a pre-determined string, and a cyclic redundancy check field.

28. A system for communicating in a network for wireless communication of uncompressed video, the device comprising:
a wireless communication subsystem to wirelessly transmit and/or wirelessly receive uncompressed video over a high rate channel; and
an encoder to encode a data packet comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses and a data field;
wherein the wireless communication subsystem transmits the encoded data packet over a low rate channel associated with a first bandwidth that is smaller than a second bandwidth associated with the high rate channel.

29. The system of claim 28, wherein frequency bands of the low and high rate channels at least partially overlap.

30. The method of claim 28, wherein the low and high rate channels use one or more of TDD (time division duplexing), FDMA (frequency division multiple access) and CDMA (code division multiple access).

31. The system of claim 28, wherein the data packet further comprises a preamble comprising a predetermined bit pattern.

32. The system of claim 31, wherein the preamble is characterized by having a duration in a range of about 40 microsec. to about 60 microsec.

33. The system of claim 29, wherein the frequency band of the high rate channel is within a range of frequencies from about 57 GHz to about 66 GHz.

34. The system of claim 28, wherein the plurality of MDA messages in the received data packet comprise information identifying time slot information associated with a plurality of devices, wherein the time slot information represents reserved time periods, within a superframe period of a predetermined length, for the plurality of devices to receive or transmit on at least one of the low rate and the high rate channels.

35. The system of claim 28, the plurality of information fields further including one or more of a packet type field, an acknowledgement policy field, a field used to indicate that a packet is a retransmission of a previously transmitted packet, a field used to indicate if more data packets are to be transmitted within a time period, a sequence number field, a delimiter field set to a pre-determined string, and a cyclic redundancy check field.

36. An system for communicating in a network for wireless communication of uncompressed video, the apparatus comprising:
communication means for wirelessly transmitting and/or wirelessly receiving uncompressed video over a high rate channel; and
means for encoding a data packet comprising a plurality of information fields including a source identification field and a field identifying the packet as containing a plurality of messages, the data packet further comprising a plurality of multiple destination aggregation (MDA) messages, wherein each of the MDA messages comprises a receiver identification field containing one or more destination addresses and a data field;
wherein the communication means transmits the encoded data packet over a low rate channel associated with first bandwidth that is smaller than a second bandwidth associated with the high rate channel.
